(19) United States
(12) Patent Application Publication
(10) Pub. No.: US 2005/0073909 A1
(43) Pub. Date: Apr. 7, 2005

(54) Determination of the height of the surface of a fluid column

(76) Inventors: Robert Laws, Cambridge (GB); Johan Olaf Anders Robertsson, Oslo (NO); Julian Edward Kragh, Essex (GB); Leendert Combee, Oslo (NO)

Correspondence Address: WILLIAMS, MORGAN & AMERSON, P.C., 10333 RICHMOND, SUITE 1100, HOUSTON, TX, 77042, US

(21) Appl. No.: 10/492,874

(22) PCT Filed: Sep. 18, 2002
(86) PCT No.: PCT/GB02/04244

(30) Foreign Application Priority Data
Sep. 18, 2001 (GB) 01224658

(51) Int. Cl. G01V 1/38

(52) U.S. Cl. 367/15

(57) ABSTRACT

The invention concerns a method for reducing the effect of a rough sea ghost reflection in marine seismic data. According to the invention, the method comprises the steps of: providing one or a plurality of pressure sensors sensitive to frequencies below about 1 Hz;—using said sensor(s) to receive and acquire pressure data in a frequency band comprised between about 0.03 and about 1 Hz;—recording said data; and—processing said data to provide information about the sea-height above the or each sensor. The or each sensor may be a seismic sensor that can acquire seismic data substantially simultaneously with the acquisition of the pressure data in a frequency band between about 0.03 and about 1 Hz.

The present invention relates to a method of and a system for determining the height of a surface of a fluid column above a sensor. The method may be of use in, for example, marine seismic data acquisition.

Marine seismic data acquisition may be achieved by seismic vessels towing a seismic source and/or one or a plurality of instrumented cables packed with sensors. In conventional marine surveys, those instrumented cables, called streamers, are towed approximately horizontally at a depth between about 5 and about 50 meters.

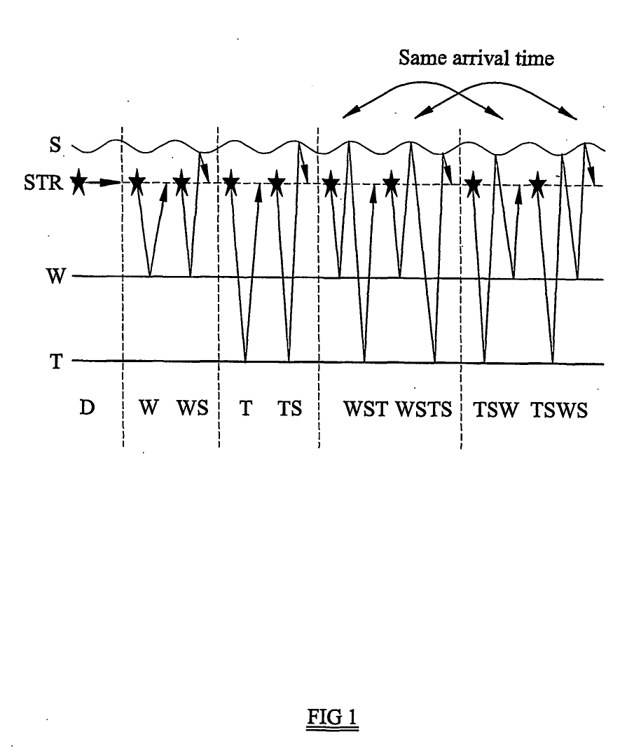

FIG. 1 is a schematic diagram showing the various events that can be acquired by a towed streamer “STR” and recorded in a seismogram. These events are shown and labelled according to the series of interfaces they are reflected at, said interfaces being referenced “S” for the rough sea surface, “W” for the sea floor and “T” for a target reflector. The stars indicate seismic sources and the arrowheads indicate the direction of seismic wave propagation at the receiver. Events comprising an “S” are reflected at the rough sea surface and are called ghost events.

Ghost events are an undesirable source of perturbations, which affect the response of a receiver and the shape of the source pulse, hence obscuring the interpretation of the desired up-going reflections from the earth's sub-surface.

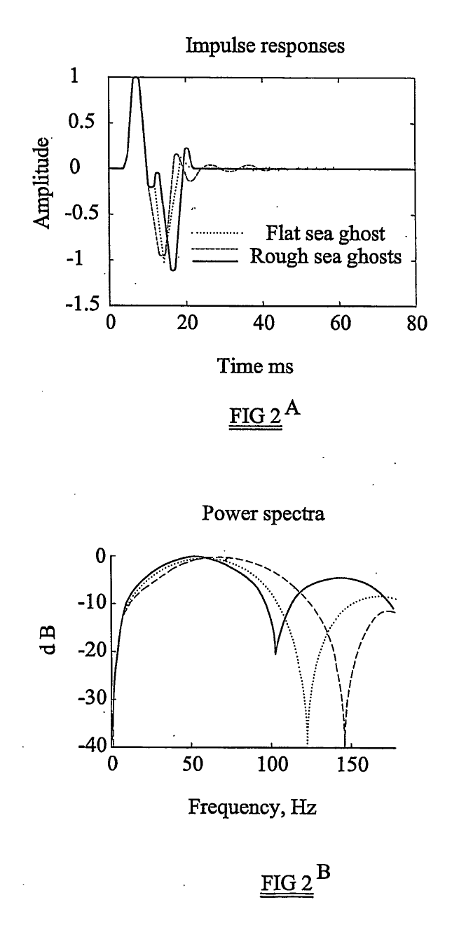

The effect of the rough sea is to perturb the amplitude and arrival time of the sea surface reflection ghost and to add a scattering coda or tail to the ghost impulse. FIGS. 2A and 2B compare two typical rough sea impulse responses to a flat sea impulse response. Those responses, which are simulated, are computed at a single point located at a nominal 6-meter depth below the mean sea level. In one rough sea response, there is an increase in both the ghost arrival time and amplitude. In the other response, there is a decrease. The pulse shape is also perturbed. There is a trailing coda at later times resulting from scattered energy from increasingly distant parts of the surface which gives rise to ripples on the amplitude spectra. The spectral ripples in the 10-80 Hz region can be a significant source of error.

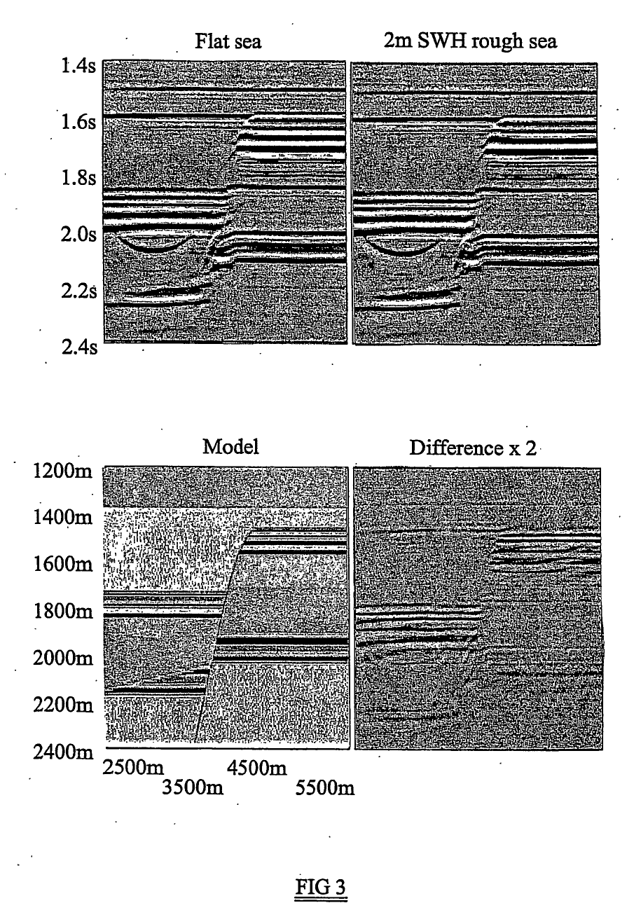

FIG. 3 is a simulation, which illustrates how the rough sea effect can degrade a seismic image. It also illustrates how that degradation may be significant, in particular, for time-lapse surveys, wherein seismic images are made at different times, for example, one year apart, in order to evaluate, notably, the change of the oil level of a reservoir. The panel on the bottom left shows a section of a subterranean earth model. The panel on the top left is a representation of the seismic data that can be acquired from this model, with a flat sea, and the panel on the top right is a representation of the data that can be acquired from said model, with a 2 m Significant Wave Height (SWH) rough sea, in a time-lapse survey. Finally, the panel on the bottom right is a difference between these two representations multiplied by a factor of 2, which has been caused by the roughness of the sea. It clearly appears that the rough sea effect can degrade the seismic image and that this degradation can be significant and may mask a genuine difference.

Various patent applications disclose methods for correcting or reducing the rough sea effect in seismic data. This is the case, in particular, of the methods disclosed in the applications published under the numbers WO 00/57206 and WO 00/57207. Normally, the seismic signals received by the seismic sensors are filtered before being recorded so that data below about 3 Hz are rejected. Some ghost correction methods depend on knowing the height of the sea surface as a function of time, above each source or receiver. The sea surface shape is then extrapolated away from the sensor. This extrapolation may simply be a plane passing through the measured height or may be more elaborate. Nevertheless, none of these methods discloses how the height of the sea surface may be measured using, in particular, streamers of the state of the art.

Considering the above, one problem that the invention is proposing to solve is to carry out an improved method for determining the height of the surface of a fluid column.

The proposed solution to the above problem is defined in claim 1.

The time-varying shape of the sea surface gives rise to pressure waves, and these sea surface pressure waves occupy the frequency band comprised between about 0.03 and 0.5 Hz. However, because of the movement of the sensors relative to the waves, said frequency band is extended to about 0.03 to 1 Hz by the Doppler effect. According to the invention, the data of the 0.03-1 Hz frequency band are not only received and acquired by the sensors, but they are also recorded and processed to provide an estimate of the sea surface elevation above each sensor.

Further aspects and preferred features of the invention are defined in the other claims.

The invention will be better understood in the light of the following description of non-limiting and illustrative embodiments, given with reference to the accompanying drawings, in which:

FIG. 1 is a schematic diagram showing the various events that may be received by sensors of a towed streamer;

FIGS. 2A and 2B show typical perturbations caused by a rough sea as compared to a flat sea;

FIG. 3 shows a model and three seismic images of said model, which illustrate the degrading effect of a rough sea;

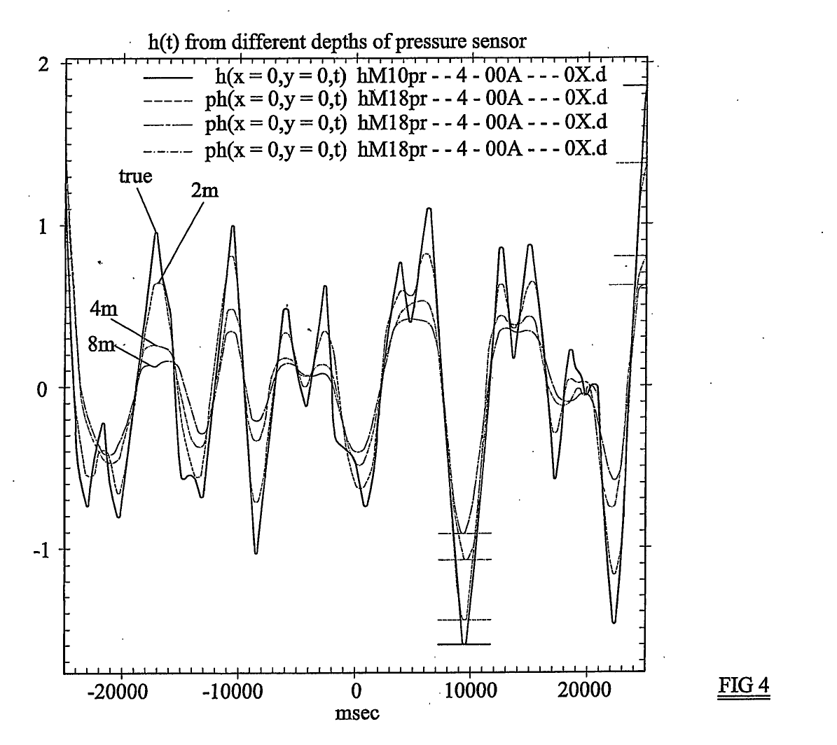

FIG. 4 illustrates the smoothing effect for various depths of sensors;

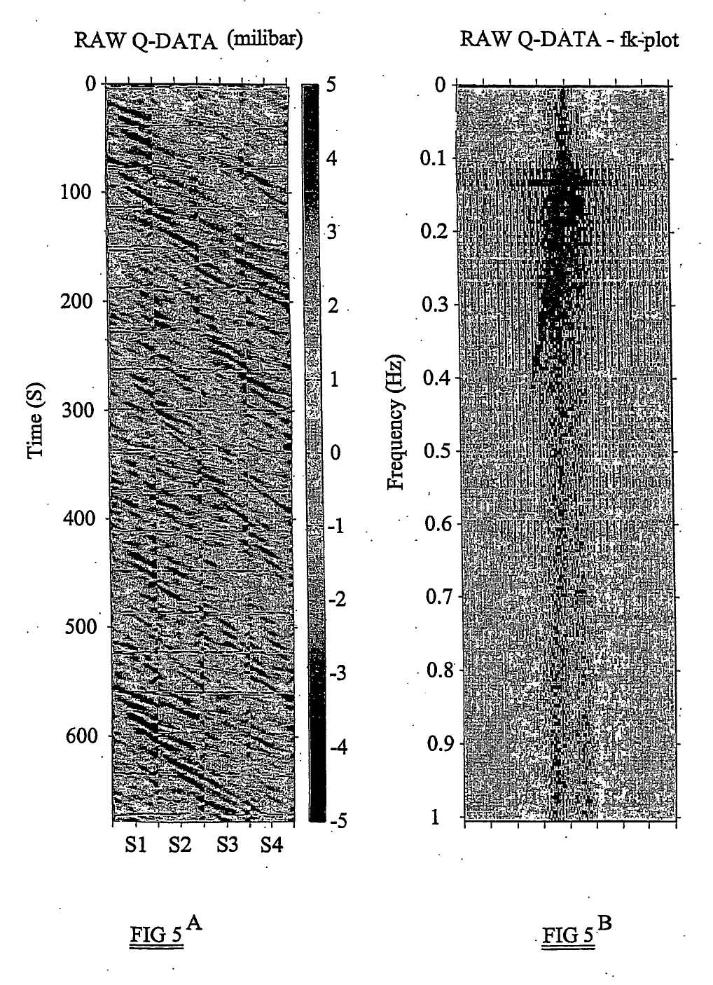

FIGS. 5A and 5B show the Q raw data that may be acquired and recorded according to the invention;

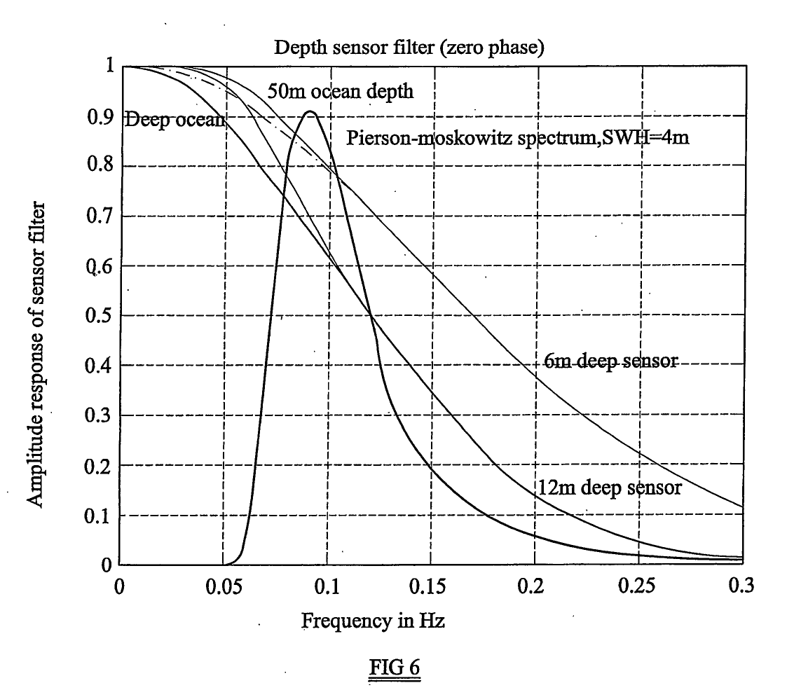

FIG. 6 shows depth filter curves for two different sensor depths and two different sea depths and compares these curves with a Pierson Moskowitz spectrum for a SWH being equal to 4 m;

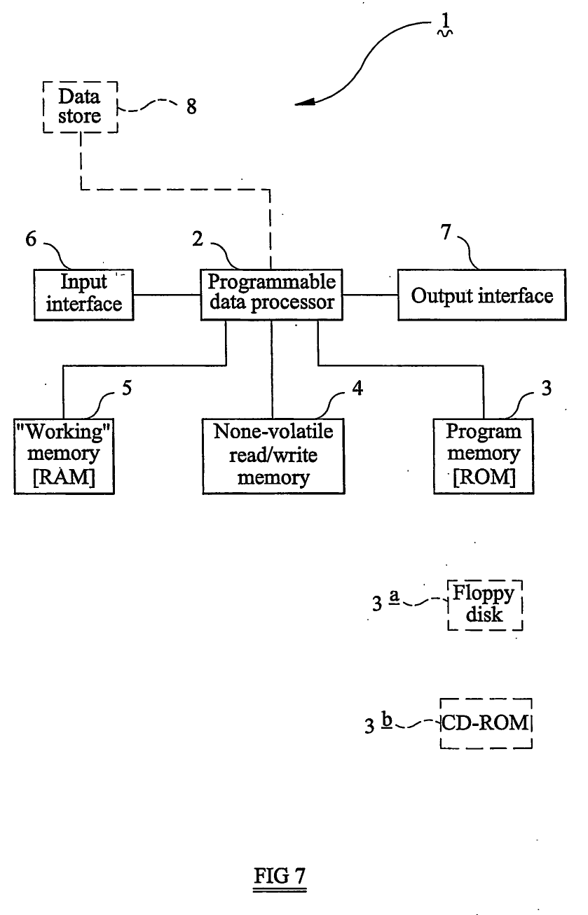

FIG. 7 shows an apparatus according to the invention; and

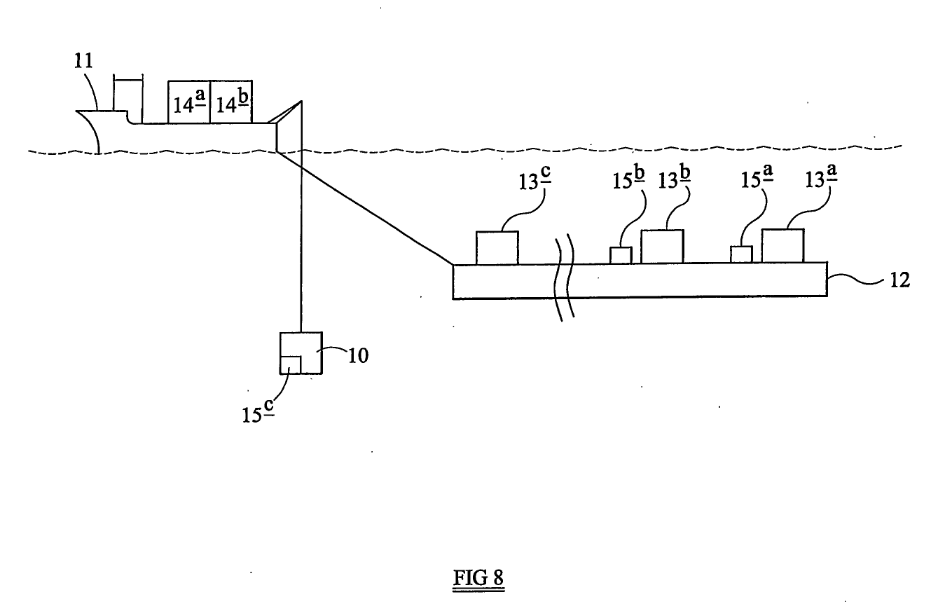

FIG. 8 shows a seismic surveying arrangement according to the invention.

The invention will be described with reference to an embodiment in which a plurality of pressure sensors, sensitive in the 0.03 Hz to 1 Hz frequency range are provided on an instrumented cable, in this example a seismic streamer, that is towed through the sea by a vessel. However, in other modes for carrying out the invention, said the pressure data in the 0.03 Hz to 1 Hz frequency range may be acquired by a sensors disposed on a plurality of streamers, by sensors disposed on one or more Ocean Bottom Cables (OBCs) laid on the seafloor, or by one or more sensors disposed adjacent to a seismic source.

A seismic streamer has a length typically of a few kilometres. According to this embodiment of the invention, a seismic streamer is provided with one or, preferably, a plurality of sensors capable of recording a stream of low frequency pressure data. Typically each sensor will digitally sample the pressure at regular time intervals, with the interval between successive sampling operations being known as the “sampling interval”.

In a particularly preferred embodiment of the invention, the sensor, or at least one of the sensors if there are more than one is advantageously a seismic sensor, that is to say a sensor that is also capable of receiving and acquiring seismic data. In a particularly preferred embodiment the or each sensor may be a seismic pressure sensor such as a hydrophone. Alternatively the or each sensor may be a comprised in a multi-component seismic receiver, for example, a 4C receiver that has geophones for measuring particle velocity in three directions (x, y and z) and a pressure sensor such as a hydrophone. Thus in this embodiment a sensor of the streamer acts both as a sensor for receiving and acquiring pressure data in the frequency range from 0.03 to 1 HZ and as a seismic sensor for acquiring seismic pressure data—in this embodiment, the seismic pressure sensors that are ordinarily disposed on a seismic streamer are themselves used to acquire the pressure data in the 0.03 Hz to 1 Hz frequency range, so that this embodiment of the invention does not require additional pressure sensors to be provided on the streamer.

Hydrophones are sensors comprising a piezo-electric device in order to measure pressure variations in a certain frequency domain. In a conventional streamer hydrophones are distributed singly or in groups along the length of the streamer, at regular intervals. For example, groups 12.5 m long and containing 12 hydrophones may be provided, or groups 6.25 m long and containing 6 hydrophones may be provided. The hydrophones or the hydrophone groups are decoupled one from the others so that all pressure data that they acquire are transmitted, after analogue-to-digital conversion and multiplexing, via optical fibres, wires or other data transmission devices, along the streamer, to a computer onboard the towing vessel where they are recorded.

An example of commercially available streamer is exploited under the appellation “Q” by the company named WesternGeco. This streamer is provided with a plurality of decoupled hydrophones that can be used as sensors according to the invention. The invention is not, however, limited to use with this particular streamer.

Typically a hydrophone or other pressure sensor disposed on a streamer is provided with, or is associated with, a digital low-cut filter, which normally blocks low-frequency pressure data, for example blocks pressure data in the frequency range below 3 Hz. Data at frequencies below 3 Hz are not normally of interest in a seismic survey, since seismic data are typically contained in approximately the 3 to 80 Hz frequency band. The low-cut filter may be applied either at the acquisition of the seismic data or later during processing of the data. In order to use a conventional hydrophone provided on a streamer as a pressure sensor for obtaining low frequency pressure data in the 0.03 to 1 Hz range it is necessary to disable the associated low-cut filter. Once the low cut filter is disabled, the hydrophones are not only able to receive and acquire seismic pressure data, which are contained in approximately the 3 to 80 Hz frequency band, but they are also able to receive and acquire pressure data at frequencies below 3 Hz which are not, by themselves, seismic data since they do not relate to the sea floor subsurface. Once the low-cut filter has been disabled, each pressure sensor is able to measure and acquire low frequency pressure data from which the height h of the sea surface above the sensor may be derived. In the case where the low-cut filter is applied during processing of the acquired data, the data received and acquired at frequencies below 3 Hz have a dynamic range high enough to permit their further use according to the invention once the low-cut filter has been disabled.

For a flat sea, the pressure below the sea surface is given by:
P₀=ρ g z (1)
where P₀ is the hydrostatic pressure sensed by the sensor, ρ is the density of the water, g is the acceleration due to gravity and z is the depth of said sensor below the Mean Sea Level (MSL). However, for a rough sea, a pressure sensor detects a pressure, which is not simply related to the height of the sea immediately above it (D. J T Carter, P. G. Challenor, J A. Ewing, E. G. Pit, M. A. Srokosk and M J Tucker, “Estimating Wave Climate Parameters for Engineering Applications”, Offshore Technology Report OTH 86 228, 1986 (Carter et al.)). Assuming that the system can be treated as linear and that the effect of different sea surface waves may be superimposed, the dynamic part of the pressure sensed by a pressure sensor is:
p=ρ g h cosh(k(d−z))/cosh(kd) (2)
wherein p is the dynamic part of the pressure, k is the wavenumber of the sea surface wave equal to 2π/λ where λ is the wave length, h is the upward displacement of the sea surface directly above the sensor, relative to MSL, and d is the ocean depth relative to MSL.

For an infinitely deep ocean, the equation (2) simplifies to:
p=ρ g h exp(−kz) (3)

It appears from equation (3) that pressure sensors are particularly sensitive to the variations in the sea height that have small wavenumbers, k compared with their depth z. Variations in the sea height that show large wavenumbers, k, and, therefore, short wavelengths, λ, are smoothed and are detected with reduced amplitude. The smoothing effect is disclosed by Carter et al.

Equation (3) may be modified if desired to take account of non-linear terms, viscosity and surface tension. The former is particularly important in the case of sea height estimation for breaking waves.

As shown in the FIG. 4, wherein depths are determined using a pressure sensor mounted at 2, 4 and 8 m below MSL and compared with the true height profile of a 4 m SWH, the error is not insignificant and the deeper the sensor is deployed, the more the height reading is smoothed. The reduction in amplitude at short wavelengths is preferably corrected for in the processing of the data.

It is known that the sea surface waves occupy the part of the frequency spectrum comprised between about 0.03 and about 0.5 Hz. Although the sea surface waves occupy the frequency range 0.03-0.5 Hz, however, this frequency range is extended to 0.03 to 1 Hz owing to the longitudinal movement of the sensor in the direction of the vessel and relative to the wave movement, according to the Doppler effect.

FIGS. 5A and 5B show an example of raw pressure data that were received or acquired, recorded and used by a Q streamer. The low cut filters associated with the pressure sensors on the streamer, which are conventional 3 Hz digital low-cut filters, had been disabled. In this case, the vessel towing the Q streamer on which the pressure sensors are mounted is sailing into the wind. In FIG. 5A, the raw data are shown. The horizontal axis shows the first 400 meters of the streamer, whereas the vertical axis shows the time in seconds. The diagonal lines in the data correspond to ocean waves travelling along above the streamer. FIG. 5B shows the fk-spectrum of the data of FIG. 5A. The branch that goes of to the left and ends somewhere at 0.5 Hz corresponds to the waves passing over the streamer. The striped pattern is a Gibbs type phenomenon that can be avoided by properly scaling the data from the different streamer segments.

Therefore, according to the invention, the sensors, sensitive to frequencies below about 1 Hz, are used to receive and acquire frequency data relating to the sea waves in a frequency band comprised between about 0.03 Hz and about 1 Hz. The data are transmitted, from the sensors, to a computer memory onboard the towing vessel. The data acquired by a sensor, or group of sensors are recorded and then processed for determining the height of the sea surface above the sensor or group of sensors.

In a preferred method of processing the low frequency pressure data to determine the height of the sea surface above the sensor, the heights that are obtained directly from the pressure measurements and recorded are corrected to take into account the movement of the sensor in the direction of the vessel. This may be done by interpolating the measurements to a line of points that are stationary in the water. If the water is moving over the ground, for example because of a tidal action, the data may also be interpolated to the frame of the water, not to the frame of the land, because it is in the water frame that the pressure waves propagate.

Once the sensor's motion has been corrected for, the pressure measurements are preferably further corrected for the smoothing effect caused by the depth of the sensor. The correction factor is derived from the above-referenced equation (2) for each k component of the surface wavefield. The k-spectrum of the surface is derived from the frequency spectrum of the pressure data and knowledge of the dispersion relation of the surface waves:
ω²=g k tanh(kd) (4)
where ω is the angular frequency of the surface wave equal to 2π/τ where τ is the wave period equal to 1/f where f is the frequency in Hz, k is the surface wavenumber and d is the ocean depth relative MSL. For an infinitely deep ocean, this reduces to:
ω²=g k (5)
So, in the deep water limit, the equations (3) and (5) give:
p(ω)=ρg h(ω) exp(−ω²z/g) (6)
which is the correction filter that may be applied according to the invention, for an infinitely deep ocean. The data from each receiver can be deconvolved without using data from the other receivers.

It is noted that the low pass filter exp(−ω²z/g) can be removed by deconvolution of the h(t) signal.

For the case of finite ocean-depth, equations (2) and (4) are combined numerically to define the filter. However, the effect of ocean depth is not large for oceans that are 50 metres deep or more. FIG. 6 shows the depth filter curves for two different sensor depths, 6 m and 12 m, and two ocean depths: infinite and 50 m. In addition, the 4 m SWH Pierson-Moskowitz isotropic ocean wave spectrum is plotted to show the active part of the spectrum. Each filter curve splits in two at low frequencies corresponding to an infinite ocean depth and 50 m ocean depth. Over the sea wave spectrum bandwidth the effect of ocean depth is small. It can be seen that the effect of the finite ocean depth on the sensor filter is small, being at most a few percent over the active part of the spectrum.

Thus, the invention provides a determination of the height of the sea surface above the or each pressure sensor. In an embodiment in which the or each pressure sensor is a seismic sensor, the invention therefore provides local sea-height data for the seismic sensors, since it provides a determination of the height of the sea surface above the or each seismic sensor.

Furthermore, as noted above, each pressure sensor will typically repeatedly sample the pressure. The data acquired in successive sampling operations may be processed as described above to provide a determination of the variation with time of the height of the sea surface above the seismic sensor.

The local sea-height data obtained for each pressure sensor has many applications.

For example, the height of the sea surface above each pressure sensor permits the reconstruction of the profile of the sea surface. This may be done using, for example, an extrapolation of the time varying surface elevation along the line of the streamer. It may alternatively be achieved by a statistical interpolation method such as that that suggested by J. Goff for determination of the seafloor profile.

Once the sea surface has been reconstructed, the reflection response of the sea-surface can be computed. This can be done, for example, by Kirchhoff integration, by a Lax-Wendroff technique, or by any other suitable technique. A deconvolution operator may then be calculated and applied to seismic data acquired at the same time as the pressure date used to obtain the profile of the sea-surface to correct the seismic data for the effects of the time-dependent height of the sea surface. For example, the estimate of the time-dependent height of the sea-surface may be used to reduce the effect of rough sea ghost reflections in the seismic data. The quality of the seismic images that are obtained is thereby improved.

The sea height data obtained from the low frequency pressure data may be used to correct seismic pressure data obtained by the same sensor for the effect of the time-dependent height of the sea surface. It may also be used to correct other seismic data—for example, if the low frequency pressure data is acquired by a pressure sensor located in a 4C seismic receiver, the sea height data obtained from the low frequency pressure data may be used to correct, for example, particle velocity data acquired by a geophone in the 4C receiver as well as to correct seismic pressure data.

The sea-height data obtained by a method of the invention may alternatively be used to determine the state of the sea-surface, in particular to estimate the wave height, and this is known as “sea state QC”. Sea state QC is currently carried out by making a visual observation of the sea surface and assigning a numerical value to the wave height. According to the present invention, however, the wave height of the sea surface may be determined from the local sea height data obtained from the low frequency pressure measurements, or from the re-constructed profile of the sea surface derived from the local sea height data. This provides a more accurate determination of the wave height than can be obtained by visual observation.

The local sea height data provided by the present invention may also be used to ensure that the streamer is correctly levelled. Generally, it is desired for a streamer to be substantially level (horizontal in the water) during a seismic survey. Local sea height data may be obtained according to the invention after a streamer has been placed in the water, and this will show whether the streamer is level in the water, and also whether the streamer is at its desired depth below the mean sea level. The streamer, or one or more segments of the streamer, can be adjusted as necessary, and once the local sea height data indicates that the streamer has been adjusted to be level and at the correct depth the streamer is then ready for seismic data acquisition.

The local sea height data may be monitored during a survey to ensure that the streamer remains level and at its desired depth during a survey. For example, if the local sea height data showed that the depth of one section of the streamer was increasing, whereas the depth of other sections of the streamer has remained substantially unaltered, this would strongly suggest that a leak had occurred in one section which was sinking as a result of the intrusion of sea water.

As noted above, in one preferred embodiment of the invention the low frequency pressure date is acquired using a seismic pressure sensor such as a hydrophone. This allows the low frequency pressure data to be acquired simultaneously with the seismic data This in turn allows the determination of local sea height data for times at which seismic data were acquired, for example for use in de-ghosting the seismic data. Where low frequency pressure data and seismic data are acquired together in this way, the low frequency data are preferably received and acquired simultaneously with the seismic data and over at least the same time period as the seismic data. For example, the low frequency pressure data may be acquired during a period from twenty seconds before the start of seismic data acquisition to twenty seconds after the end of seismic data acquisition.

It should be noted that, in practice, a hydrophone has an inherent low-cut filter (in addition to the digital low-cut filter referred to above). A hydrophone acts as a capacitor at low frequencies, and the electrical wiring carrying the output signal from the hydrophone will act as a resistance; furthermore the signal from a hydrophone is generally fed to a voltage amplifier, and this will have an input impedance. The hydrophone capacitance and the circuit resistance will act as a low cut filter. This low-cut filter may well attenuate the amplitude of the hydrophone output for pressure waves in the frequency range 0.03 to 1 HZ. In order to determine the local sea height accurately, a correction must be made for the effect of this low-cut filter, and this known as “backing off” the filter. If the hydrophone capacitance and the wiring resistance are determined, the acquired data can be corrected for the effect of the inherent low-cut filter.

A conventional streamer is generally provided with depth sensors, in addition to the seismic sensors. These are generally hydrostatic pressure sensors, which determine the hydrostatic pressure at frequencies below about 0.02 Hz; the depth of the sensor is obtained from the measured hydrostatic pressure, according to equation (1). (Depth sensors are generally pressure sensors with a pressure to depth conversion based on (nominal or calibrated) water density and air barometric pressure, and do not directly measure depth.) These conventional depth sensors may be used to check the quality of, or calibrate, the low frequency pressure data acquired by a hydrophone. Such a check is useful, since the noise content of a hydrophone output can be significant at low frequencies. The calibration provided by a depth sensor operating at 0.02 Hz or below may well extend well beyond the hydrophones located closest to the depth sensor, because the very low frequencies at which the depth sensor operates correspond to surface waves having a very large wavelength.

In the description of the above embodiment, the pressure data in the frequency range 0.03 Hz to 1 Hz is acquired using a seismic sensor. The invention is not limited to this, however, and it is possible for the pressure data in the frequency range 0.03 Hz to 1 Hz to be acquired using one or more separate sensors provided specifically for that purpose. For example, in such an embodiment a seismic streamer could be provided with one or more sensors, additional to the streamer's seismic sensors, for acquiring pressure data in the frequency range 0.03 Hz to 1 Hz. The additional sensors could be any pressure sensor that is capable of acquiring pressure data in the 0.03 to 1 Hz frequency range. In this embodiment the streamer has a first set of one or more sensors for acquiring the low frequency pressure data and a second set of one or more sensors for acquiring seismic data—the streamer's seismic sensors acquire seismic data, and the additional sensors on the streamer acquire low frequency surface wave pressure data.

Where the output from such additional low frequency pressure sensors is to be used in de-ghosting seismic data acquired by the seismic sensors of the streamer, each low frequency pressure sensor is preferably substantially co-located with a respective seismic sensor. Each low frequency pressure sensor is preferably placed coincident with or within about 3 m of the seismic receiver to be corrected. Furthermore, the low frequency pressure data are preferably received and acquired substantially simultaneously with the seismic data and over at least the same time period as the seismic data. For example, the low frequency pressure data may be acquired during a period from twenty seconds before the start of seismic data acquisition to twenty seconds after the end of seismic data acquisition.

Although the invention has been described above with particular reference to a seismic streamer, the invention is not limited to this but may be applied to any seismic receiver array. If the receiver array includes seismic pressure sensors the invention may be effected by using the seismic pressure sensors to acquire the low frequency pressure data, and/or by using one or more additional low frequency pressure sensors to acquire low frequency pressure data If, on the other hand, the receiver array does not include seismic pressure sensors, the invention may be effected by using one or more additional low frequency pressure sensors to acquire low frequency pressure data.

In principle, the invention may be effected using a single low frequency pressure sensor. This will, however, provide only limited information about the sea-height (namely, a single value of the sea-height above the sensor). The use of a plurality of low frequency pressure sensor is preferable, since this provides information about the height of the surface of the fluid column above each of a plurality of sensors and so allows generation of a profile of the sea surface from the information about the height of the surface of the fluid column above each of the plurality of sensors, for example by interpolation of the sea-height between these locations.

The invention has been described above with reference to one or more low frequency pressure sensors disposed on a receiver array. The invention is not limited to this, however, and may be applied to a marine seismic source array by providing one or more pressure sensors sensitive in the 0.03-1 Hz frequency band on the source array, with each sensor being associated with a seismic source or with a respective seismic source. The output from the sensors can be processed as described above to provide the local sea-height above the or each sensor. This may be used, for example, to correct the rough-sea ghost response of the source, in which case each low frequency pressure is preferably substantially co-located with its respective source, for example being placed coincident with or within about 3 m of the seismic source to be corrected.

It should be noted that the processing required to determine the localised sea height above a sensor provided in or on a source array is not exactly the same as for a sensor provided in or on a receiver array. A source array is generally suspended from a float and so is positioned at a constant distance beneath the sea surface—i.e., the source array moves up and down as the height of the sea changes. This movement of the source array introduces a Doppler shift and this must be accounted for in processing data acquired by a sensor disposed on the source array. (In contrast, a streamer is generally maintained at a constant “depth” independent of sea height/swell by depth control devices.).

FIG. 7 is a schematic block diagram of an apparatus 1 that is able to process low frequency pressure data acquired by a method according to the present invention to determine the local sea-height above the or each sensor. In a preferred embodiment, the apparatus 1 is further able to process seismic data using the local sea-heights to attenuate the effect of ghost reflections in the processed seismic data.

The apparatus 1 comprises a programmable data processor 2 with a program memory 3, for instance in the form of a read only memory (ROM), storing a program for controlling the data processor 2 to process seismic data by a method of the invention.

The apparatus further comprises non-volatile read/write memory 4 for storing, for example, any data which must be retained in the absence of a power supply. A “working” or “scratch pad memory for the data processor is provided by a random access memory RAM 5 An input device 6 is provided, for instance for receiving user commands and data. One or more output devices 7 are provided, for instance, for displaying information relating to the progress and result of the processing. The output device(s) may be, for example, a printer, a visual display unit, or an output memory.

Sets of data for processing may be supplied via the input device 6 or may optionally be provided by a machine-readable data store 8.

The results of the processing may be output via the output device 7 or may be stored. The program for operating the system and for performing the method described hereinbefore is stored in the program memory 3, which may be embodied as a semiconductor memory, for instance of the well known ROM type. However, the program may well be stored in any other suitable storage medium, such as a magnetic data carrier 3a (such as a “floppy disk”)s or a CD-ROM 3b.

FIG. 8 shows an embodiment of seismic surveying arrangement according to the present invention. The seismic surveying arrangement comprises a source array, indicated generally by 10, that contains one or more seismic sources and is suspended below the sea surface from a survey vessel 11. The seismic surveying arrangement further comprises a receiver array. This is shown as a streamer 12 that is also towed from the survey vessel in FIG. 8, but the receiver array could be any other receiver array such as, for example, a plurality of streamers or an Ocean Bottom Cable. A plurality of seismic receivers 13a, 13b, 13c each of which consists of or includes a seismic pressure sensor such as, for example, a hydrophone, are provided on the streamer. The seismic data acquired by the seismic receivers 13a, 13b, 13c are passed, via optical fibres, wires or other data transmission devices, along the streamer, to first processing and/or recording equipment 14a onboard the towing vessel 11.

References 15a and 15b each denotes a low frequency pressure sensor, that can acquire pressure data in the frequency range 0.03 to 1 Hz. Each of these is located adjacent to one seismic receiver, the receivers 13a and 13b respectively. The low frequency pressure data acquired by the pressure sensors 15a, 15b are passed to second processing and/or recording equipment 14b on the survey vessel 11, which processes the low frequency pressure data acquired by the pressure sensor 15a to obtain the local sea height above the pressure sensor 15a (which is substantially equivalent to the local sea height above the receiver 13a adjacent to the pressure sensor 15a). Similarly the low frequency pressure data acquired by the pressure sensor 15b are processed to obtain the local sea height above the pressure sensor 15b (which is substantially equivalent to the local sea height above the adjacent receiver 13b).

In practice the pressure sensors 15a, 15b will repeatedly sample the pressure in the frequency range of 0.03 to 1 Hz, so that the time-varying local sea height above each sensor may be determined. The resulting sea-height data may be used for any of the purposes described above—for example, the time-varying profile of the sea-surface may be determined from these local height measurements. (In practice, a streamer will contain many more low frequency pressure sensors than shown in FIG. 8, so that more local sea-height measurements will be available for the determination of the sea profile.) As noted above, the invention may be performed by using a seismic pressure sensor to obtain the low frequency pressure data. This is illustrated in FIG. 8 by reference 13c, which denotes a seismic receiver having a seismic pressure sensor for which the associated digital low-cut filter has been disabled and which therefore that can acquire pressure data in the approximate range of 0.03 to 1 Hz. The receiver 13c therefore does not require a co-located low frequency pressure sensor. Low frequency pressure data acquired by the receiver 13c are passed to the second processing and/or recording equipment 14b on the survey vessel 11, and seismic data acquired by the receiver 13c are passed to the first processing and/or recording apparatus 14a. The low frequency pressure data acquired by the receiver 13c are processed to obtain the local sea height above the receiver 13c.

In practice, the invention is likely to be effected either by using low frequency pressure sensors substantially co-located with each seismic receiver or by using each seismic pressure sensor to obtain low frequency pressure data by disabling the associated digital low-cut filter. The two methods are both shown in FIG. 8 primarily for the purposes of illustration although, in principle, these two method could be combined.

References 15c denotes a pressure sensor provided on the source array 10 and that can acquire pressure data in the approximate frequency range 0.03 to 1 Hz. The low frequency pressure data acquired by the pressure sensor 15c are also passed to the second processing and/or recording equipment 14b on the survey vessel 11, and may be processed to obtain the local sea height above the pressure sensor 15c (which is substantially equivalent to the local sea height above the source array 10).

The processing and/or recording apparatus 14a, 14b may be combined in a single processing and/or recording apparatus. They may comprise an apparatus 1 as shown in FIG. 7. The seismic data and low frequency pressure data may simply be recorded on the survey vessel for later processing, or one or both may be processed in real-time or near real-time (for example to monitor the depth of the streamer).

1. A method of determining the height of the surface of a fluid column, the method comprising the steps of:
providing a sensor within a fluid column, the sensor being sensitive to pressure waves at frequencies below about 1 Hz;
using said sensor to receive and acquire pressure data in a frequency band comprised between about 0.03 Hz and about 1 Hz; and
processing said pressure data to obtain information about the height of the surface of the fluid column above the sensor.

2. A method according to claim 1, wherein the sensor is comprised in an array of seismic sensors.

3. A method according to claim 1, wherein the sensor is comprised in an instrumented cable.

4. A method according to claim 2, wherein the sensor, is a seismic sensor.

5. A method according to claim 4, wherein the seismic sensor receives and acquires seismic data substantially simultaneously to the receiving and the acquiring of the pressure data in the frequency bank comprised between about 0.03 Hz and about 1 Hz.

6. A method according to claim 4, wherein the seismic sensor is a hydrophone.

7. A method according to claim 3, wherein the instrumented cable is a towed streamer comprising a plurality of decoupled sensors.

8. A method according to claim 1, wherein the sensor is associated with a seismic source or with a respective seismic source.

9. A method according to claim 1, further comprising the step of correcting the acquired pressure data to take into account the movement of the sensor relative to the fluid column.

10. A method according to claim 1, wherein the step of processing said pressure data comprises applying the following correction filter to the pressure data acquired by a sensor:
p(ω)=ρ g h (ω) exp(−ω²z/g)
where p(ω) is the pressure sensed by the sensor, ρ is the density of the fluid, g is the acceleration due to gravity, z is the depth of the sensor below the Mean Sea Level, ω is the angular frequency of the surface wave and h is the upward displacement of the surface of the fluid column directly above the sensor and relative to the Mean Sea Level.

11. A method according to claim 1, wherein the step of processing said pressure data comprises applying a correction filter to the data acquired by a sensor, said correction filter being a numerical combination of the following equations:
p=ρ g h cosh(k(d−z))/cosh(kd)
and
ω²=g k tanh (kd)
where p is the pressure sensed by the sensor, ρ is the density of the water, g is the acceleration due to gravity, z is the depth of said sensor below the Mean Sea Level, ω is the angular frequency of the surface wave, d is the ocean depth relative to the Mean Sea Level and h is the upward displacement of the sea surface directly above the sensor and relative to the Mean Sea Level.

12. A method as claimed in claim 1, wherein the step of processing said pressure data comprises the steps of: obtaining information about the height of the surface of the fluid column above each of a plurality of sensors; and generating a profile of the sea surface from the information about the height of the surface of the fluid column above each of the plurality of sensors.

13. A method of processing seismic data, the method comprising the steps of:
providing a first sensor within a fluid column, the first sensor being sensitive to pressure waves at frequencies down to about 0.03 Hz;
providing a second sensor within the fluid column, the second sensor being a seismic sensor;
using said first sensor to receive and acquire pressure data in a frequency band comprised between about 0.03 Hz and about 1 Hz;
using said second sensor to receive and acquire seismic data substantially simultaneously with the step of receiving and acquiring the pressure data;
processing said pressure data to obtain information about the height of the surface of the fluid column above the first sensor; and
processing the seismic data using the information about the height of the surface of the fluid column above the first sensor thereby to attenuate effects of a rough sea ghost reflection in the processed seismic data.

14. A method as claimed in claim 13 wherein the first sensor is substantially co-located with the or a respective second sensor.

15. A method as claimed in claim 13 wherein the first sensor is the second sensor.

16. A method as claimed in claim 13, wherein the step of processing the seismic data comprises:
computing a reflection response by Kirchhoff integration;
calculating a deconvolution operator; and
applying said deconvolution operator to the seismic data.

17. A system for determining the height of the surface of a fluid column, the system comprising:
a sensor within a fluid column, or the each sensor being adapted to, in use, receive and acquire pressure data in a frequency band comprised between about 0.03 Hz and about 1 Hz; and
processing apparatus for processing said pressure data to obtain information about the height of the surface of the fluid column above the sensor.

18. A system as claimed in claim 14 wherein the processing apparatus comprises a programmable data processor.

19. A data carrier containing a stored program for a programmable data processor of a system as defined in claim 15.

20. A computer programmed to perform a method as defined in claim 1.

21. A program for programming a computer to perform a method as defined in claim 1.

22. A seismic surveying arrangement comprising:
a seismic source disposed within a fluid column;
a first sensor disposed within the fluid column and spaced from the seismic source, the sensor being adapted to receive and acquire pressure data in a frequency band comprised between about 0.03 Hz and about 1 Hz;
a second sensor, the second sensor being adapted to receive and acquire seismic data substantially simultaneously with the acquisition of the pressure data;
first processing apparatus for processing said pressure data to obtain information about the height of the surface of the fluid column above the first sensor; and
second processing apparatus for processing the seismic data using the information about the height of the surface of the fluid column above the first sensor thereby to attenuate effects of a rough sea ghost reflection in the processed seismic data.

23. A seismic surveying arrangement as claimed in claim 22 wherein the first sensor is substantially co-located with the second sensor.

24. A seismic surveying arrangement as claimed in claim 22 wherein the first sensor is the second sensor.

25. A seismic surveying arrangement as claimed in claim 22, wherein the first processing apparatus is the second processing apparatus.

26. A seismic surveying arrangement as claimed in claim 22 wherein the first processing apparatus comprises a programmable data processor.

27. A data carrier containing a stored program for a programmable data processor of a seismic surveying arrangement as defined in claim 26.
